(19) United States
(12) Patent Application Publication
(10) Pub. No.: US 2007/0030271 A1
(43) Pub. Date: Feb. 8, 2007

(54) Robot controller and robot control method using spline interpolation

(75) Inventor: Koji Kamiya, Anjo-shi (JP)

Correspondence Address: OLIFF & BERRIDGE, PLC, P.O. BOX 19928, ALEXANDRIA, VA, 22320, US

(73) Assignee: DENSO WAVE INCORPORATED, Tokyo (JP)

(21) Appl. No.: 11/499,813

(22) Filed: Aug. 7, 2006

(30) Foreign Application Priority Data
Aug. 5, 2005 (JP) 2005-228089

(51) Int. Cl. G06T 11/20

(52) U.S. Cl. 345/442

(57) ABSTRACT

A determining unit determines tangent vectors at one and the other end of one spline curve segment of each section such that a length of each tangent vector is proportional to that of a first straight line connecting one end and the other end of the one spline curve segment, and that the tangent vectors at one end and the other end of the one spline curve segment are directed to divide, by a predetermined ratio, a first angle and a second angle, respectively. The first angle is formed by the first straight line and an extension of a second straight line connecting one and the other ends of a previous spline curve segment. The second angle is formed by the fist straight line and an extension of a third straight line connecting one and the other ends of a next spline curve segment.

### CROSS REFERENCE TO RELATED APPLICATIONS

This application is based on Japanese Patent Application 2005-228089 filed on Aug. 5, 2005. This application claims the benefit of priority from the Japanese Patent Application, so that the descriptions of which are all incorporated herein by reference.

### FIELD OF THE INVENTION

The present invention relates to robot controllers and robot control methods, which are capable of performing spline interpolation on a plurality of command points given at intervals, thereby determining a trajectory of one end of a robot arm.

### BACKGROUND OF THE INVENTION

Playback robots are normally designed such that a teaching box teaches a robot controller a plurality of command points of one end of a robot arm (manipulator); these command points include a starting point, an endpoint, and intermediate points therebetween. To the one end of the manipulator, a mechanical hand is attached. The robot controller is programmed to execute interpolation on the taught command points to determine a trajectory passing through the command points. Next, the robot controller is programmed to lubricously move the one end of the robot arm along the determined trajectory.

As methods of interpolation on a plurality of command points, a spline interpolation method using spline function is in common use today. Some of examples of the spline interpolation method are disclosed in Japanese Unexamined Patent Publications No. S64-081012 and No. H07-064620.

When the variation range of a parameter t is set to a range from 0 to 1, spline interpolation method is designed to:

divide the variation range into a plurality of sections (segments);

interpolate curves in the sections by different polynomials, respectively; and

link the curves to define a spline curve within the range from 0 to 1.

A curve in each section, referred to as “spline curve segment” hereinafter, is defined to meet a plurality of conditions at both ends thereof; these conditions are associated with positions and tangent vectors at both ends of each spline curve segment.

Specifically, the adjacent spline curve segments are linked to one another to meet the following (A) to (C) conditions to obtain a lubricous spline curve (trajectory) passing through the command points in the order from the starting point to the endpoint:

The condition (A) is that the positions at one ends of adjacent spline curve segments coincide with each other; these one ends constitute a knot between the adjacent spline curve segments

The condition (B) is that the tangent vectors at one ends of adjacent spline curve segments coincide with each other

The condition (C) is that the rates of tangent vectors at one ends of adjacent spline curve segments coincide with each other

As set forth above, upon teaching of a plurality of command points the one end of the robot arm, the conventional robot controller determines a lubricous spline curve sequentially passing through the command points.

If an interval between one pair of adjacent command points is shorter than another interval between another pair of adjacent command points, a spline curve segment in the corresponding short interval may be looped as illustrated in FIG. 9. Otherwise if all intervals have the same length, there can be no looped spline curve segments.

At a spline curve segment corresponding to part, which is desired to be gently curved in a substantially linear fashion, of a trajectory to be obtained, the interval of adjacent command points corresponding to the spline curve segment can be set to be relatively longer than another interval corresponding to another part of the trajectory.

At a spline curve segment corresponding to part, which is desired to be sharply curved, of a trajectory to be obtained, the interval of adjacent command points corresponding to the spline curve segment need be set to be relatively shorter than another interval corresponding to another part of the trajectory.

As set forth above, in order to obtain a spline curve without looped portions in a case where a desired trajectory of one end of a robot arm includes at least one gently curved part and at least one sharply curved part, it is necessary to teach a robot controller a plurality of command points in such a manner that:

at least one interval of a pair of adjacent command points corresponding to the at least one gently curved part is shorter to be identical to at least one interval of another pair of adjacent command points corresponding to the at least one sharply curved part.

This means that it is required to teach the robot controller a large number of command points in order to obtain a spline curve without looped portions. This may take a long time to perform the command point teaching operation, thereby deteriorating the efficiency of determining a trajectory of one end of a robot arm.

### SUMMARY OF THE INVENTION

In view of the background, an object of an aspect of the present invention is to provide robot controllers and robot control methods, which are capable of obtaining a spline curve without looped portions even if a plurality command points are different from each other in length.

According to one aspect of the present invention, there is provided a controller for determining a spline curve as a trajectory of a predetermined movable portion of a robot body. The controller includes an interpolating unit configured to sequentially interpolate spline curve segments respectively in sections corresponding to intervals between command points. The controller also includes a tangent vector determining unit configured to determine tangent vectors at one and the other end of one spline curve segment of each of the sections such that a length of each of the tangent vectors is proportional to that of a first straight line connecting one end and the other end of the one spline curve segment, and that the tangent vectors at one end and the other end of the one spline curve segment are directed to divide, by a predetermined ratio, a first angle and a second angle, respectively. The first angle is formed by the first straight line and an extension of a second straight line connecting one and the other ends of a previous spline curve segment. The second angle is formed by the fist straight line and an extension of a third straight line connecting one and the other ends of a next spline curve segment. The controller further includes a linking unit configured to link the spline curve segments such that a direction of one of the tangent vectors at the one end of the one spline curve segment is substantially the same as that of one of the tangent vectors at the same end of the previous spline curve segment, and that a direction of the other of the tangent vectors at the other end of the one spline curve segment is substantially the same as that of one of the tangent vectors at the same end of the next spline curve segment.

According to one aspect of the present invention, there is provided a program product embedded in a memory of a controller for determining a spline curve as a trajectory of a predetermined movable portion of a robot body. The program product includes first means for instructing a controller to sequentially interpolate spline curve segments respectively in sections corresponding to intervals between command points. The program product also includes second means for instructing a controller to determine tangent vectors at one and the other end of one spline curve segment of each of the sections such that a length of each of the tangent vectors is proportional to that of a first straight line connecting one end and the other end of the one spline curve segment, and that the tangent vectors at one end and the other end of the one spline curve segment are directed to divide, by a predetermined ratio, a first angle and a second angle, respectively. The first angle is formed by the first straight line and an extension of a second straight line connecting one and the other ends of a previous spline curve segment. The second angle is formed by the fist straight line and an extension of a third straight line connecting one and the other ends of a next spline curve segment. The program product further includes third means for causing a controller to link the spline curve segments such that a direction of one of the tangent vectors at the one end of the one spline curve segment is substantially the same as that of one of the tangent vectors at the same end of the previous spline curve segment, and that a direction of the other of the tangent vectors at the other end of the one spline curve segment is substantially the same as that of one of the tangent vectors at the same end of the next spline curve segment.

According to a further aspect of the present invention, there is provided a method of determining a spline curve as a trajectory of a predetermined movable portion of a robot body. The method includes sequentially interpolate spline curve segments respectively in sections corresponding to intervals between command points. The method also includes determining tangent vectors at one and the other end of one spline curve segment of each of the sections such that a length of each of the tangent vectors is proportional to that of a first straight line connecting one end and the other end of the one spline curve segment, and that the tangent vectors at one end and the other end of the one spline curve segment are directed to divide, by a predetermined ratio, a first angle and a second angle, respectively. The first angle is formed by the first straight line and an extension of a second straight line connecting one and the other ends of a previous spline curve segment. The second angle is formed by the fist straight line and an extension of a third straight line connecting one and the other ends of a next spline curve segment. The method further includes linking the spline curve segments such that a direction of one of the tangent vectors at the one end of the one spline curve segment is substantially the same as that of one of the tangent vectors at the same end of the previous spline curve segment, and that a direction of the other of the tangent vectors at the other end of the one spline curve segment is substantially the same as that of one of the tangent vectors at the same end of the next spline curve segment.

### BRIEF DESCRIPTION OF THE DRAWINGS

Other objects and aspects of the invention will become apparent from the following description of embodiments with reference to the accompanying drawings in which:

FIG. 1 is a perspective view schematically illustrating an example of the hardware configuration of a robot according to a first embodiment of the present invention;

FIG. 2 is a block diagram schematically illustrating an example of the system configuration of the robot illustrated in FIG. 1;

FIG. 3 is a view schematically illustrating examples of velocity pattern and motion angle pattern to be used by the controller illustrated in FIGS. 1 and 2;

FIG. 4 is a view schematically illustrating an example of a trajectory containing a plurality of command points according to the embodiment;

FIG. 5 is a view schematically illustrating tangent vectors at ends of spline curve segments according to the embodiment;

FIG. 6 is an enlarged view schematically illustrating the relationship between a unit vector inside the first term of each of equations [14] and [15] and that inside the second term thereof according to the embodiment;

FIG. 7 is an enlarged view schematically illustrating the relationship between a unit vector inside the first term of each of equations [16] and [17] and that inside the second term thereof according to the embodiment;

FIG. 8 is a flowchart schematically illustrating operations to be executed by a controller illustrated in FIG. 1; and

FIG. 9 is a trajectory containing a plurality of command points according to a related art of the present invention.

### DETAILED DESCRIPTION OF EMBODIMENTS OF THE INVENTION

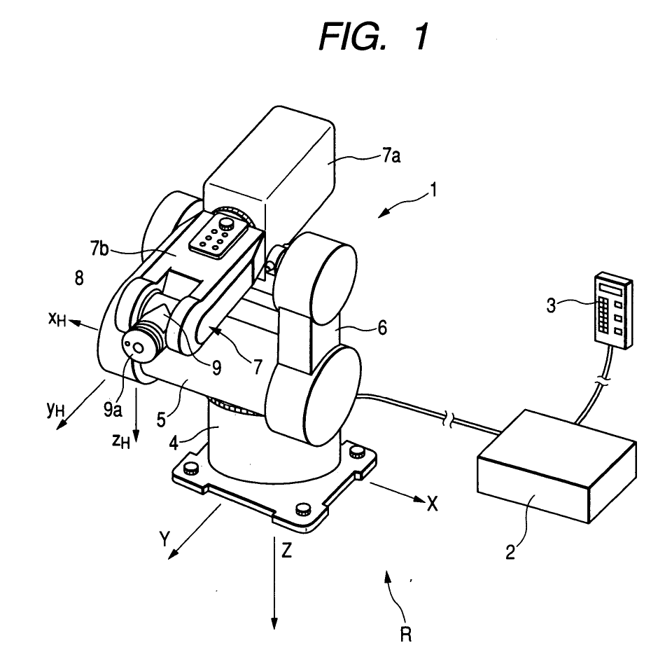

An embodiment of the present invention will be described hereinafter with reference to the FIGS. 1 to 6.

A robot (robot arm) R according to the embodiment includes a robot body 1, a controller 2 for controlling the robot body 1, and a teaching pendant 3 as a teaching box for the controller 2. The robot body 1 is electrically connected to the controller 2, and the controller 2 is electrically connected to the teaching pendant 3 through a cable.

As illustrated in FIG. 1, the robot body 1 as a control target for the controller 2 is designed as, for example, a vertical articulated robot.

Specifically, the robot body 1 is composed of a substantially cylindrical-shaped base 4 mounted on a horizontal plane, and a substantially cylindrical-shape shoulder joint 5 mounted on the base 4 such that the center axial direction of the shoulder joint 5 is orthogonal to the center axial direction of the base 4. The shoulder joint 5 is configured to be horizontally rotatable on the base 4 about a center axis thereof.

The robot body 1 is also composed of a pair of upper arms (upper arm joints) 6. One ends of the pair of upper arms 6 are pivotally supported by both ends of the shoulder joint 5 about the center axis thereof in the vertical direction corresponding to the center axial direction of the base 4.

The robot body 1 is composed of a lower arm (lower arm joint) 7 pivotally supported by the other ends of the upper arms 6 in the vertical direction corresponding to the center axial direction of the base 4.

The lower arm 7 includes a base 7a and an arm body 7b extending from the base 7a and rotatably supported thereby about the extending direction. The tip end of the arm body 7b is forked.

The robot body 1 is composed of a substantially cylindrical-shaped wrist joint 8 inserted between the forked ends of the arm body 7b and pivotally supported thereby in the vertical direction corresponding to the center axial direction of the base 4.

The wrist joint 8 is formed with a flange 9 projecting therefrom. The flange 9 has a tip end to be rotatable about the projecting direction such that the tip end permits the mounting of a mechanical hand (mechanical gripper) that can grip various types of tools. The tip end 9a of the flange 9 will be also referred to as “hand joint” hereinafter.

The robot R also includes a number of motors 10 as actuators. For example, in the embodiment, DC (Direct Current) servo motors can be preferably used as the motors 10.

Specifically, the base 4 is integrated with at least one of the motors 10 and a rotation transmission system (not shown) that transfers rotation of at least one of the motors 10 to the shoulder joint 5 to horizontally rotate it.

The shoulder joint 5 is integrated with at least one of the motors 10 and a rotation transmission system (not shown) that transfers rotation of at least one of the motors 10 to the upper arms 6 to vertically pivot them together with each other.

The upper arm joints 6 are integrated with at least one of the motors 10 and a rotation transmission system (not shown) that transfers rotation of at least one of the motors 10 to the lower arm joint 7 to vertically pivot it. The base 7a of the lower arm joint 7 is integrated with at least one of the motors 10 and a rotation transmission system (not shown) that transfers rotation of at least one of the motors 10 to the arm body 7b of the lower arm joint 7 to rotate about the extending direction.

The arm body 7b is integrated with at least one of the motors 10 and a rotation transmission system (not shown) that transfers rotation of at least one of the motors 10 to the wrist joint 8 to vertically pivot. The flange 9 is integrated with at least one of the motors 10 and a rotation transmission system (not shown) that transfers rotation of at least one of the motors 10 to its hand joint 9a (together with the mechanical hand) to rotate about the projecting direction of the flange 9.

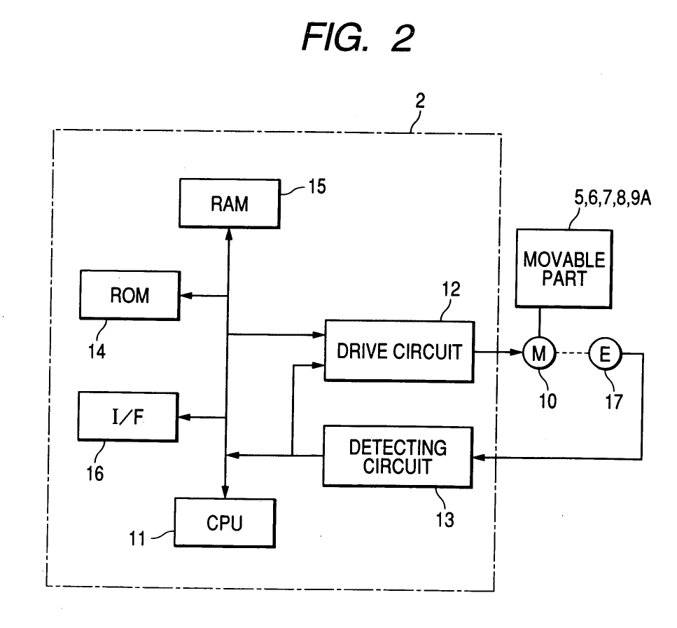

As illustrated in FIG. 2, the controller 2 includes a CPU 11 serving as a control unit, drive circuits 12 for driving the motors 10, a detecting circuit 13, a ROM (Read Only Memory, such as an EEPROM, flash ROM, or the like) 14, a RAM (Random Access Memory) 15, and an interface (I/F) 16. The elements 12 to 16 are electrically connected to the CPU 11.

The ROM 14 has stored therein system programs that cause the CPU 11 to control the system resources of the robot R.

The RAM 15 has stored therein a robot motion program and the like.

The I/F 16 is designed to be electrically connectable to the teaching pendant 3.

Note that, in FIG. 2, the shoulder joint 5, the upper arm joints 6, the lower arm joint 7, the wrist joint 8, and the hand joint 9a of the flange 9 are collectively illustrated as a movable part by one block to which reference numerals 5, 6, 7, 8, and 9a are assigned. The driving sources of the movable parts (joint portions) 5, 6, 7, 8, and 9a are collectively illustrated as one block to which reference numeral 10 is assigned.

The detecting circuit 13 is operative to detect the current position and the current angular velocity of each of the joint portions 5, 6, 7, 8, and 9a

Specifically, a rotary encoder 17 is attached to, for example, the rotating shaft of each of the motors 10, and is electrically connected to the detecting circuit 13.

The rotary encoder 17 serves as both a position sensor and a speed sensor. Specifically, the rotary encoder 17 is configured to output digital pulses that correspond to incremental angular motion (revolution) of the rotating shaft of each of the motors 10. The pulse signal consisting of the train of the digital pulses is given to the detecting circuit 13.

The detecting circuit 13 is operative to detect, based on the pulse signal sent from each of the rotary encoders 17, the current position of the rotating shaft of each of the motors 10, and therefore, the current position of each of the joint portions 5, 6, 7, 8, and 9a.

In addition, the detecting circuit 13 is operative to:

count the number of the pulses in the pulse signal input from each of the rotary encoders 17 per unit of time; and

detect, based on the counted result, the current angular velocity of the rotating shaft of each of the motors 10, and therefore, the current angular velocity of each of the joint portions 5, 6, 7, 8, and 9a.

The detecting circuit 13 is also operative to give each of the drive circuits 12 and the CPU 11 information indicative of the current position and current angular velocity of each of the joint portions 5, 6, 7, 8, and 9a.

each of the drive circuits 12 is operative to:

compare a position command value and an angular velocity command value for motion of each of the movable parts 5, 6, 7b, 8, and 9a, which are given from the CPU 11, with the current position and current angular velocity of each of the joint portions 5, 6, 7, 8, and 9a, which are given from the detection circuit 13, respectively; and

supply, to each of the corresponding motors 10, a drive current depending on the deviation between the position command value for motion of each of the joint portions 5, 6, 7, 8, and 9a and the current position for motion thereof and that between the angular velocity command value for motion of each of the joint portions 5, 6, 7, 8, and 9a and the current angular velocity thereof, thereby rotatably driving each of the motors 10.

This allows the predetermined center position of the tip end 9a of the flange 9 corresponding to one end of the robot body 1 to move along a trajectory passing through the command points corresponding to the position command values. This makes it possible for the robot body 1 to carry out various jobs.

In the robot motion program to be stored in the RAM 15, parameters including a velocity coefficient and an acceleration/deceleration coefficient of each of the motors 10 have been previously recorded.

The velocity coefficient is defined as the proportion of the maximum velocity of the arm's motion to a maximum permissible velocity of each of the motors 10. The acceleration/deceleration coefficient is also defined as the proportion of the acceleration/deceleration of the arm's motion to a maximum permissible acceleration/deceleration of each of the motors 10.

The maximum permissible velocity and the maximum permissible acceleration/deceleration have been determined in view of the performance of each of the motors 10 and that of each of the rotation transmission systems for transferring rotation of at least one of the motors 10 to corresponding one of the joints on the conditions that the load torque of each of the motors 10 will not exceed a maximum permissible torque thereof.

The CPU 11 is operative to apply a velocity pattern of the motion of the one end of the robot body 1 from its start position to its end position to a trapezoidal pattern using the parameters recorded in the motion program, thereby determining a trapezoidal velocity pattern of the motion of the one end of the robot body 1.

In addition, the CPU 11 is operative to:

calculate an angular velocity and a position (location) of each joint of the robot body 1 based on the determined trapezoidal velocity pattern every elapse of a predetermined period; and

give the calculated angular velocity and position to the drive circuit 12 as the angular velocity command value and the position command value.

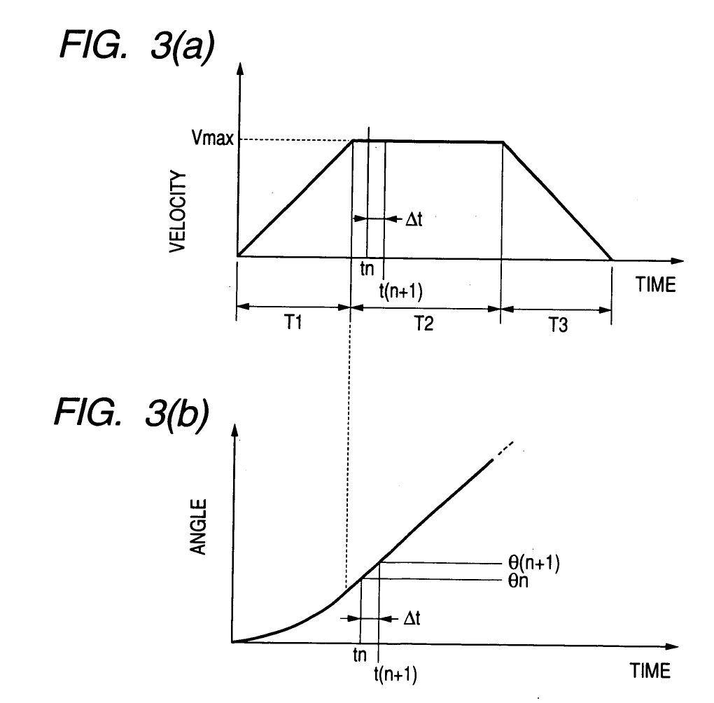

Specifically as illustrated by (a) of FIG. 3, the trapezoidal velocity pattern is composed of a first portion corresponding to an acceleration phase during a period T1, a second portion corresponding to a constant-velocity phase with a maximum velocity during a period T2, and a third portion corresponding to a deceleration phase T3 during a period T3. A pattern of a motion angle (position) corresponding to the trapezoidal velocity pattern illustrated by (a) of FIG. 3 is illustrated by (b) of FIG. 3.

In the motion angle pattern illustrated by (b) of FIG. 3, the motion angle of a joint at a point “tn” in time is represented by θn, and the motion angle of the joint at a point “t(n+1)” in time after a lapse of Δt from the point “tn” in time is represented by “θ(n+1)”.

The angle variation after lapse of Δt corresponds to the angler velocity, represented by “V(n+1)”, of the joint at a point “t(n+1)” in time. The angular velocity V(n+1) is used as the angular velocity command value at the point “tn” in time. The angular velocity command value (the angular velocity V(n+1)) is fed to the drive circuit 12.

In addition, the motion angle θ(n+1) of the joint at the point t(n+1) in time after a lapse of Δt from the point “tn” in time can be obtained by adding the product of the angular velocity V(n+1) at the point t(n+1) in time and Δt to the motion angle θ(n) of the joint at the point t(n) in time.

Thus, during the interval of time between the point of motion start and the point of motion end, the angle of each joint every elapse of the sampling period Δt can be calculated in the following way. Each time one sampling period Δt elapses after the point of motion start, the angular velocity of each joint at a next sampling point (a point in time after lapse of the time interval Δt from the present point in time) is calculated in accordance with the velocity pattern. The calculated velocity is multiplied by the sampling period Δt. The previous and latest multiplication resultant values are added. The result of the addition indicates the angle of joint every elapse of the sampling period Δt. Information of the calculated angle of the joint is fed to the drive circuit 12.

Note that how to calculate an angular velocity and a position (location) of each joint of the robot body 1 has been include in, for example, U.S. Patent Publication No. U.S. Pat. No. 6,127,792. Because the U.S. patent is assigned to the same assignee as that of this application, disclosures of which are incorporated herein by reference.

The teaching pendant 3 is designed to a handheld device composed of an input unit, a display unit, a memory unit, and a computing, which allow execution of basic functions, such as program start function, trajectory teaching function, machine lock functions, error message displaying functions, and the like. This handheld configuration of the teaching pendant 3 allows an operator to control the robot body 1 through the controller 2 while observing the motion of the robot body 1.

Specifically, in the embodiment, information indicative of a desired trajectory of the one end of the robot body 1 is given to the controller 3 by teaching tasks of the teaching pendant 3.

The teaching tasks include a task of sequentially teaching the controller 2 a plurality of command points of the one end of the manipulator R; these command points pass through the desired trajectory, and include a starting point, an endpoint, and intermediate points therebetween.

The teaching tasks also include a task of teaching a desired pose of the one end of the robot body 1 at each of the command points.

The controller 2 receives the taught command points and the desired pose of the one end of the robot body 1 at each of the command points, and stores them in the RAM 15.

In actually making the robot body 1 move, the controller 2 is programmed to:

execute interpolation on the taught command points to determine a trajectory passing through the command points in the order from the starting point to the endpoint; and

lubricously move the one end of the robot body 1 along the determined trajectory.

Note that, in the embodiment, as illustrated in FIG. 1, a robot coordinate system (X, Y, Z) is established independently of the motion of the one end of the robot body 1.

For example, the robot coordinate system (X, Y, Z) is, for example, established such that the Z axis thereof coincides with the center axis of the base 4.

In addition, in the embodiment, a fixed three-dimensional coordinate system is established dependently on the motion of the one end of robot body 1, in other words, the hand mounted thereto. The three-dimensional coordinate system has the origin corresponding to the center position of the tip end 9a of the flange 9, which will be referred to as “hand coordinate system (x_{H}, y_{H}, z_{H})”.

Specifically, the position of the one end of the robot body 1 is represented by where the origin of the hand coordinate system (x_{H}, y_{H}, z_{H}) (the center position of the tip end 9a of the flange 9) is located on the robot coordinate system (X, Y, Z).

In addition, the pose of the one end of the robot body 1 is defined by, on the robot coordinate system, orientations of unit vectors on predetermined two axes in the three axes of the hand coordinate system (x_{H}, y_{H}, z_{H}). The controller 2 is also operative to execute interpolation on the poses of the one end of the robot body 1 at the command points to determine a locus corresponding to the poses of the one end of the robot body 1 at the command points; and

lubricously move the one end of the robot body 1 such that the pose of the one end of the robot body 1 lubricously varies along the determined locus.

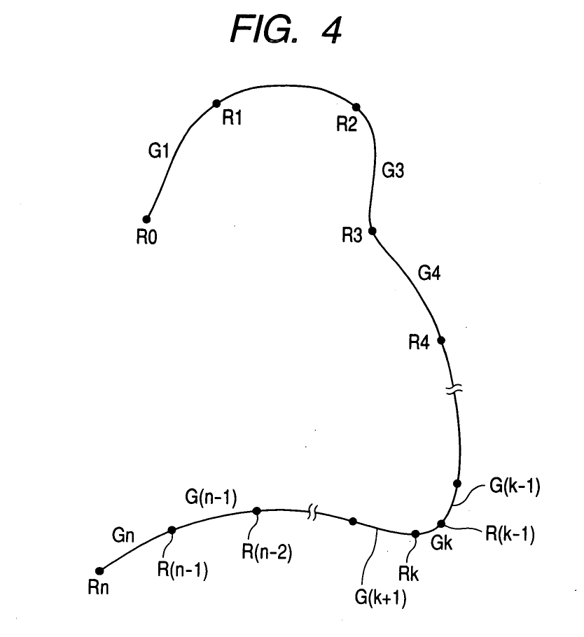

In the embodiment, as methods of interpolation on the plurality of command points, a spline interpolation method using spline function is used. As an example of the spline interpolation method according to the embodiment will be described in reference with FIG. 4.

In FIG. 4, R0, R1, . . . , R(k−1), Rk, R(k+1), . . . , Rn−1, Rn respectively represent a (n+1) number of command points, the R0 represents the starting point, and the Rn represents the endpoint. Note that “n” is an integer equal to or more than 2, and “k” is an integer equal to or more than 1, and less than n.

In addition, curves G1, G2, . . . , G(k−1), Gk, G(k+1), . . . , Gn−1, Gn each of which links between a section formed by corresponding adjacent command points represent spline curve segments. The spline curve segments G1 to Gn are defined to interpolate corresponding sections by different polynomials, respectively. The spline interpolation method defines a spline curve by spline curve segment function corresponding to each of the spline curve segments.

Specifically, each point on each of the spline curve segments can be defined as a point on the three-dimensional robot coordinate system (X, Y, Z) by the following cubic polynomials [1] to [3]:
X(t)=a₃t³+a₂t²+a₁t+a [1]
Y(t)=b₃t³+b₂t²+b₁t+b [2]
Z(t)=c₃t³+c₂t²+c₁t+c [3]

where t is a parameter set to a range from 0 to 1.

Combine the cubic polynomials [1] to [3] allows a position of each point on each spline curve segment to be therefore defined by the following cubic general polynomial (spline curve segment function) [4]:
\vec{P}(t) \vec{A}t³+\vec{B}t²+\vec{C}t+\vec{D} [4]

where \vec{P} represents a position on each spline curve segment, \vec{A}, \vec{B}, \vec{C}, \vec{D} represent vector coefficients, respectively.

Solving the vector coefficients \vec{A}, \vec{B}, \vec{C}, \vec{D} of the spline curve segment Gk, the following equations [9] to [12] can be obtained.

Specifically, because a position of a starting-point side command point of the k-th spline curve segment Gk can be assumed to “R(k−1)”, and that of the endpoint side command point thereof can be assumed to “R(k)”, position vectors of the both ends of the k-th spline curve segment Gk can be represented by \vec{P}(k−1) and \vec{P}k.

Then, the position vectors \vec{P}(k−1) and \vec{P}(k) of the both ends of the spline curve segment Gk should meet the following equations:
\vec{P}(0)=\vec{A}0=\vec{P}(k−1) [5]
\vec{P}(1)=\vec{A}+\vec{B}+\vec{C}+\vec{D}=\vec{P}k [6]

where 0≦t≦1

In addition, the tangent vectors at the position R(k−1) at a starting-point side command point and the position R(k) at the endpin side command point are given by \vec{P}′(t)=3\vec{A}t²+2 B̅t+\vec{C} that can be obtained by differentiating the equation [4] with respect to t. Assuming that the tangent vectors at the position R(k−1) at a starting-point side command point and the position R(k) at the endpoint side command point are represented by \vec{T}(k−1) and \vec{T}k, the following equations are established:
\vec{P}′(0)=\vec{A}=\vec{T}(k−1) [7]
\vec{P}′(1)=3\vec{A}+2 B̅+\vec{C}=\vec{T}k [8]

The above equations [5] to [8] allow the vector coefficients \vec{A}, \vec{B}, \vec{C}, \vec{D} of the spline curve to be represented by the following equations [9] to [12]:
\vec{A}=2\vec{P}(k−1)−2\vec{P}k+\vec{T}(k−1)+\vec{T}(k) [9]
\vec{B}=3\vec{P}k−3\vec{P}(k−1)−2\vec{T}(k−1)−\vec{T}(k) [10]
\vec{C}=\vec{T}(k−1) [11]
\vec{D}=\vec{P}(k−1) [12]

The equations [9] to [12] allow the equation [4] to be represented by the following general equation [13]:
\vec{P}(t)={2(\vec{P}(k−1)t+\vec{T}(k−1)+\vec{T}k}·t³+
{{3(\vec{P}k−\vec{P}(k−1)t−2\vec{T}(k−1)−\vec{T}k}t²+
\vec{T}(k−1)·t+\vec{P}(k−1) [13]

As described above, when one section is defined to one interval between adjacent command points, the spline curve segment in each section is represented by the general equation [13].

Specifically, the spline curve segments are determined such that the tangent vectors \vec{T}(k−1) and \vec{T}k meet the following first to third conditions:

the first condition is that the positions at one ends of adjacent spline curve segments coincide with each other; these one ends constitute a knot between the adjacent spline curve segments

the second condition is that:
the magnitude (length) of each of tangent vectors at both ends (position of a starting-point side command point and that of an endpoint side command point) of one spline curve segment is determined to be proportional to the length of a first straight line connecting the both ends of one spline curve segment,
the tangent vectors at both ends of one spline curve segment are directed to divide in substantially half a first angle and a second angle, respectively; this first angle is formed by the first straight line and a second straight line connecting both ends of the previous spline curve segment, and this second angle is formed by the fist straight line and a third straight line connecting both ends of the next spline curve segment,

the third condition is that the direction of a tangent vector at a position of a starting-point side command point of one spline curve segment is substantially the same as that of a tangent vector at a position of an endpoint side command point of the previous spline curve segment and as that of a tangent vector at a position of a starting-point side command point of the next spline curve segment

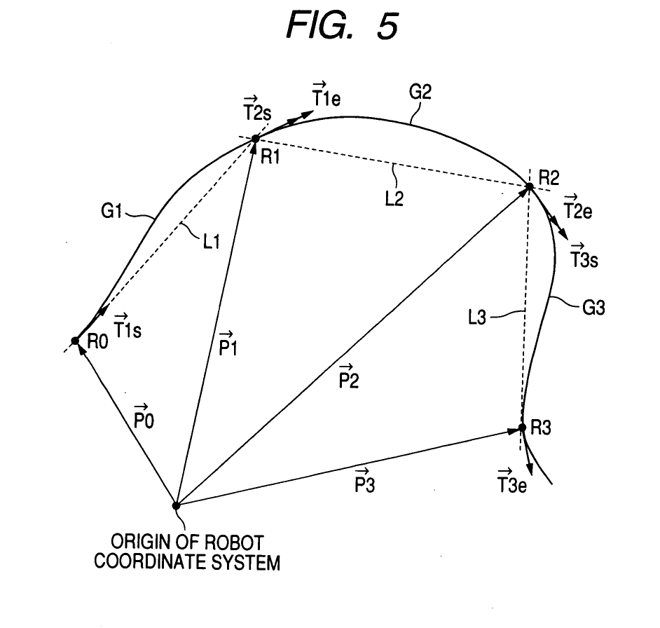

Next, the first to third conditions will be described in detail by taking the second spline curve segment (k=2; a section between the starting-point side command point R1 and the endpoint side command point R2). Note that FIG. 5 enlarges the range between the command point R3 and the command point R1 and displays it.

In FIG. 5, the straight line connecting between the both ends (the command points R0 and R1) of the first spline curve segment (k=1) is represented by L1, and the straight line connecting between the both ends (the command points R1 and R2) of the second spline curve segment (k=2) is represented by L2. Similarly, the straight line connecting between the both ends (the command points R2 and R3) of the second spline curve segment (k=2) is represented by L3.

The tangent vectors at both ends (the starting-pint side and endpoint side command points R0 and R1) of the first spline curve segment G1 are represented by a starting-point side tangent vector \vec{T}1s and an endpoint side tangent vector \vec{T}1e.

Similarly, the tangent vectors at both ends (the starting-point side and endpoint side command points R1 and R2) of the second spline curve segment G2 are represented by a starting-point side tangent vector \vec{T}2s and an endpoint side tangent vector \vec{T}2e. In addition, the tangent vectors at both ends (the starting-point side and endpoint side command points R2 and R3) of the third spline curve segment G3 are represented by a starting-point side tangent vector \vec{T}3s and an endpoint side tangent vector \vec{T}3e.

In the embodiment, the endpoint side tangent vector \vec{T}1e of the first spline curve segment G1, the starting-point side tangent vector \vec{T}2s of the second spline curve segment G2, and the endpoint side tangent vector \vec{T}2e of the second spline curve segment G2 can be represented by the following equations (14) to (16). Similarly, the starting-point side tangent vector \vec{T}3s of the third spline curve segment G3 and the endpoint side tangent vector \vec{T}3e of the third spline curve segment G3 can be represented by the following equations (17) and (18):

$$\begin{matrix}{T}^{->} 1 e = 0.5 \cdot ( \frac{{P}^{->} 1 - {P}^{->} 0}{\vert {P}^{->} 1 - {P}^{->} 0 \vert} + \frac{{P}^{->} 2 - {P}^{->} 1}{\vert {P}^{->} 2 - {P}^{->} 1 \vert} ) \cdot r \cdot \vert {P}^{->} 1 - {P}^{->} 0 \vert & [ 14 ] \\ {T}^{->} 2 s = 0.5 \cdot ( \frac{{P}^{->} 1 - {P}^{->} 0}{\vert {P}^{->} 1 - {P}^{->} 0 \vert} + \frac{{P}^{->} 2 - {P}^{->} 1}{\vert {P}^{->} 2 - {P}^{->} 1 \vert} ) \cdot r \cdot \vert {P}^{->} 2 - {P}^{->} 1 \vert & [ 15 ] \\ {T}^{->} 2 e = 0.5 \cdot ( \frac{{P}^{->} 2 - {P}^{->} 1}{\vert {P}^{->} 2 - {P}^{->} 1 \vert} + \frac{{P}^{->} 3 - {P}^{->} 2}{\vert {P}^{->} 3 - {P}^{->} 2 \vert} ) \cdot r \cdot \vert {P}^{->} 2 - {P}^{->} 1 \vert & [ 16 ] \\ {T}^{->} 3 s = 0.5 \cdot ( \frac{{P}^{->} 2 - {P}^{->} 1}{\vert {P}^{->} 2 - {P}^{->} 1 \vert} + \frac{{P}^{->} 3 - {P}^{->} 2}{\vert {P}^{->} 3 - {P}^{->} 2 \vert} ) \cdot r \cdot \vert {P}^{->} 3 - {P}^{->} 2 \vert & [ 17 ] \\ {T}^{->} 3 e = 0.5 \cdot ( \frac{{P}^{->} 3 - {P}^{->} 2}{\vert {P}^{->} 3 - {P}^{->} 2 \vert} + \frac{{P}^{->} 4 - {P}^{->} 3}{\vert {P}^{->} 4 - {P}^{->} 3 \vert} ) \cdot r \cdot \vert {P}^{->} 4 - {P}^{->} 3 \vert & [ 18 ]\end{matrix}$$

Note that, because there is no previous spline curve segment of the starting-point side tangent vector \vec{T}1s of the first spline curve segment G1, the magnitude of the starting-point side tangent vector \vec{T}1s is set to the product of the length of the first straight line L1 and a proportional constant “r”. The direction of the starting-point side tangent vector \vec{T}1s is set to be the same as that of the first straight line L1.

In the equations [14] to [18], the “r” is a proportional constant whose value is equal to that of the proportional constant “r” used by obtaining the magnitude of the starting-point side tangent vector \vec{T}1s. In the embodiment, the value of the proportional constant “r” is set to “1”.

In the equations [14] to [18], the symbols \vec{P}0, \vec{P}1, \vec{P}2, \vec{P}3 each with an arrow are position vectors at the command points R0, R1, R2, and R3, respectively.

For this reason, in the equations [14] and [15], the first term inside the parenthesis represents a unit vector \vec{L} 1 whose direction is the same as that of the first straight line L1, and the second term thereinside represents a unit vector \vec{L} 2 whose direction is the same as that of the second straight line L2.

Similarly, in the equations [16] and [17], the first term inside the parentheses represents a unit vector \vec{L} 2 whose direction is the same as that of the second straight line L2, and the second term thereinside represents a unit vector \vec{L} 3 whose direction is the same as that of the third straight line L3.

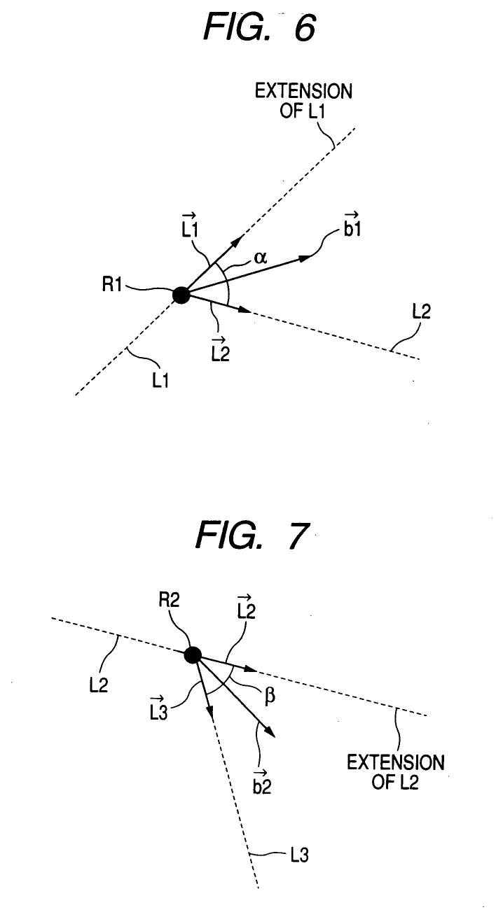

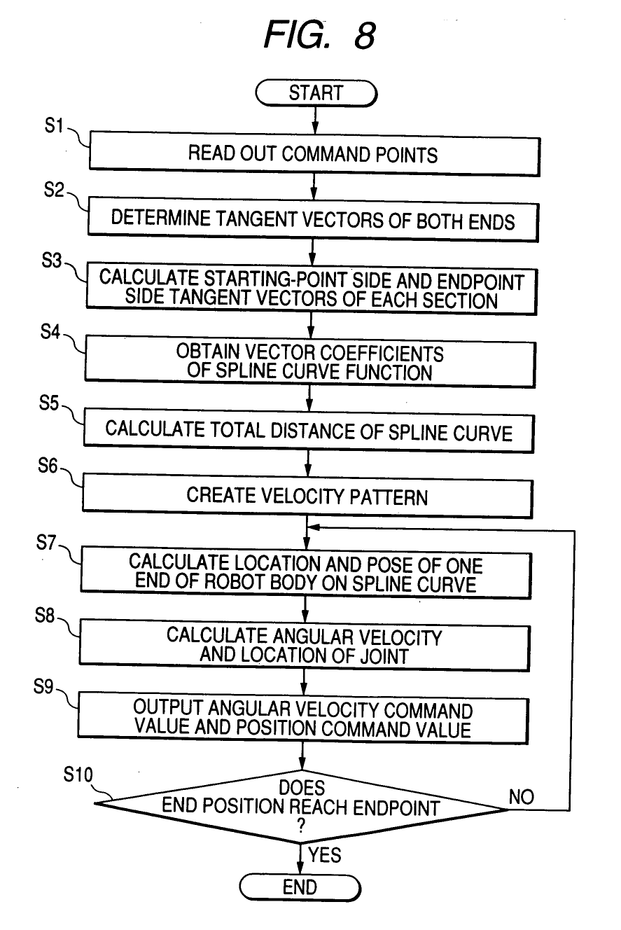

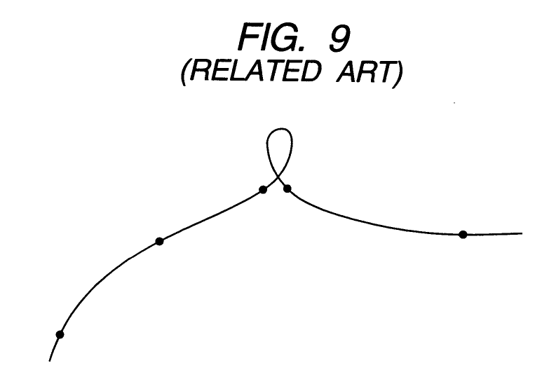

Calculation of the equations inside the parentheses in the equations [14] and [15] allows the sum of the unit vector \vec{L} 1 and the unit vector \vec{L} 2 to be obtained. As illustrated in FIG. 6, the sum of the unit vector \vec{L} 1 and the unit vector \vec{L} 2 represents a unit vector \vec{b} 1 on the bisector of an angle α formed by an extension of the first straight line L1 and the second straight line L2. Multiplication of the unit vector \vec{b} 1 by an actual number, such as ½ (0.5) permits the bisector of the angle α formed by the extension of the first straight line L1 and the second straight line L2 to be calculated.

Similarly, calculation of the equations inside the parentheses in the equations [16] and [17] allows the sum of the unit vector \vec{L} 2 and the unit vector \vec{L} 3 to be obtained. As illustrated in FIG. 7, the sum of the unit vector \vec{L} 2 and the unit vector \vec{L} 3 represents a unit vector \vec{b}2 on the bisector of an angle β formed by an extension of the second straight line L2 and the third straight line L3 to be calculated. Multiplication of the unit vector \vec{b} 2 by an actual number, such as ½ (0.5) permits the bisector of the angle β formed by the extension of the second straight line L2 and the third straight line L3 to be calculated.

As set forth above, calculations using the equations [14] to [18] allow the starting-point side tangent vector and the endpoint side tangent vector for each of the spline curve segments to be obtained.

Thereafter, as set forth above, the four spline parameters \vec{A}, \vec{B}, \vec{C}, \vec{D} of each of the spline curve segments are obtained using the starting-point side tangent vector and the endpoint side tangent vector of each of the spline curve segments. Thus, the spline curve segment function (cubic general polynomial) having the following characteristics can be obtained:

the first characteristic is that the direction of the starting-point side tangent vector of each of the spline curve segments is substantially the same as that of the endpoint side tangent vector of the previous spline curve segment

the second characteristic is that the direction of the endpoint side tangent vector of each of the spline curve segments is substantially the same as that of the starting-point side tangent vector of the next spline curve segment

This allows the spline curve (spline function) lubricously continuing at each of the command points (knots) to be obtained.

Next, operations of the controller 2 for causing the robot body 1 to carry out various jobs will be described hereinafter.

Before causing the robot R to carry out various tasks, an operator uses the teaching pendant 3 to actually move the robot body 1 under control of the controller 2, thereby teaching the controller 2 the command points of the one end (tip end 9a of the flange 9) of the robot body 1 and a desired pose of the one end of the robot body 1 at each of the command points. The command points are determined for a desired trajectory and include a starting point, an endpoint, and intermediate points. The command points taught by the teaching pendant 3 are stored in the RAM 15 by the CPU 11.

Note that the descriptions associated with the control of the pose at each command point will be omitted to simplify the descriptions of the operations of the controller 2.

When a start command is input from the teaching pendant 3 to the controller 2 for example, the CPU 11 of the controller 2 reads out the command points from the RAM 15 in step S1, and determines tangent vectors at the starting point and those at the endpoint in step S2.

In this determination in step S2, the tangent vector at the starting point is set to have the direction similar to that of a straight line connecting between the starting point and the next command point, and have the length proportional to that of the straight line. Similarly, the tangent vector at the endpoint is set to have the direction similar to that of a straight line connecting between the endpoint and the previous command point, and have the length proportional to that of the straight line. Note that the direction and length of the tangent vectors at each of the starting point and endpoint is not limited to those set forth above. Specifically, the direction and length of the tangent vectors at each of the starting point and endpoint can be determined with consideration given to the directions and lengths of the remaining tangent vectors. According to the circumstances, the length of the tangent vectors at each of the starting point and endpoint can be set to zero.

Next, the CPU 11 of the controller 2 divides the range between the starting point and the endpoint at the intermediate points into a plurality of sections (segments), and calculates the starting-point side tangent vector and the endpoint side tangent vector for each of the sections in accordance with the equations [14] to [18] in step S3.

Subsequently, the CPU 11 obtains the vector coefficients \vec{A}, \vec{B}, \vec{C}, \vec{D} of the cubic general polynomial (spline curve function; see the equation [4]) defining a spline curve segment of each of the sections in accordance with the equations [9] to [12] in step S4.

The cubic general polynomial (spline curve function) and the obtained vector coefficients \vec{A}, \vec{B}, \vec{C}, \vec{D} link provide the spline curve lubricously linking all of the command points from its starting point to its endpoint.

Thereafter, the CPU 11 differentiates the equation [13] with reference to “t” (0≦t≦1) to obtain an equation, and integrates the obtained equation from 0 to 1, thereby obtaining the total distance of the spline curve from the starting point to the endpoint in step S5.

Because the obtained total distance of the spline curve means the travel distance of the one end of the robot body 1 from the starting point to the endpoint, the CPU 11 creates the trapezoidal velocity pattern illustrated by (a) of FIG. 3 in step S6.

As set forth above, the trapezoidal velocity pattern is defined such that the locus of the velocity change of the one end of the robot body 1 has substantially a trapezoidal shape. Specifically, the trapezoidal velocity pattern is composed of:

a first portion corresponding to an acceleration phase during a period T1;

a second portion corresponding to a constant-velocity phase with a maximum velocity during a period T2; and

a third portion corresponding to a deceleration phase T3 during a period T3.

Thereafter, the CPU 11 calculates the moving distance of the one end of the robot body 1 within every constant sampling period based on the trapezoidal velocity pattern in step S7. In addition, in step S7, the CPU 11 adds the moving distance within a current sampling period to that within the previous sampling period to obtain the end position of the movement of the one end of the robot body 1 on the spline curve within the current sampling period. Moreover, in step S7, the CPU 11 calculates the pose of the one end of the robot body 1.

Next, the CPU 11 calculates the angular velocity and the location of each joint of the robot body 1 required to move the one end of the robot arm 1 from its motion start position to its the end position of the movement thereof within the corresponding sampling period in step S8. Subsequently the CPU 11 outputs the calculated angular velocity and the location of each joint of the robot 1 as the angular velocity command value and the position command value to the drive circuit 12 in step S9.

Next, the CPU 11 determines whether the end position of the one end of the robot body 1 reaches the endpoint entered by the operator as the command point.

If it is determined that the end position of the one end of the robot body 1 does not reach the endpoint entered by the operator as the command point (the determination in step S10 is NO), the CPU 11 returns to step S7. Then, the CPU 11 repeatedly executes the tasks of steps S7 to S10 until it is determined that the end position of the one end of the robot body 1 reaches the endpoint entered.

Thus, if it is determined that the end position of the one end of the robot body 1 reaches the endpoint entered by the operator as the command point (the determination in step S10 is YES), the CPU 11 determines that the one end of the robot body 1 has completely reached to the endpoint.

As described above, according to the embodiment, in order to obtain a lubricous spline curve (trajectory) without loop portions, the spline curve segments are determined such that the tangent vectors of both ends of each spline curve segment meet conditions associated with their directions independently of the following conditions:

the tangent vectors at one ends of adjacent spline curve segments coincide with each other

the rates of tangent vectors at one ends of adjacent spline curve segments coincide with each other

That is, the inventor of the present invention has found that appearance of loop portions is probably attributable to the conditions set forth above.

Thus, in the embodiment of the present invention, adoption of new conditions associated with their directions independently of the conditions associated with the coincidences of the adjacent spline curve segments themselves and of their rates allows obtaining a lubricous spline curve (trajectory) without loop portions.

Particularly, according to the embodiment, the controller 2 is configured to determine the tangent vector at both ends (command points) of a spline curve segment of each section such that:

the magnitude of each of the tangent vectors at both ends of a spline curve segment is proportional to the length of a first straight line connecting the both ends of one spline curve segment;

the tangent vector at one end of one spline curve segment is directed to divide in half a first angle formed by the first straight line and an extension of a second straight line connecting both ends of the previous spline curve segment; and

the tangent vector at the other end of one spline curve segment is directed to divide in half a second angle formed by an extension of the first straight line and a third straight line connecting both ends of the next spline curve segment.

This can prevent loop portions from appearing in the created spline curve (trajectory) even if the command points are different from each other in length.

This is because:

(1) the starting-point side tangent vector of one starting-side end of each spline curve segment is so determined as to be directed more closely toward the endpoint-side end of each spline cure segment

(2) since the magnitudes of the starting-point side tangent vector and the endpoint-side tangent vector of each spline curve segment are identical to each other and proportional to the magnitude of a straight line connecting both ends of each spline curve segment, when an angle formed by the starting-point side tangent vector of each spline curve segment and an extension of a straight line connecting both ends of the previous spline curve segment is identical to that formed by the starting-point side tangent vector and a straight line connecting both ends of each spline curve segment, adjacent spline curve segments are similar to each other.

It is possible to mathematically prove that the embodiment of the present invention allows obtaining a spline curve without loop portions.

In the embodiment, the tangent vectors at both ends (command points) of a spline curve segment of each section are determined such that:

the tangent vector at one end of one spline curve segment is directed to divide in half a first angle; this first angle is formed by the first straight line and an extension of a second straight line connecting both ends of the previous spline curve segment; and

the tangent vector at the other end of one spline curve segment is directed to divide in half a second angle, this second angle is formed by an extension of the first straight line and a third straight line connecting both ends of the next spline curve segment.

However, the present invention is not limited to the structure.

Specifically, the tangent vectors at both ends (command points) of a spline curve segment of each section can be determined such that:

the tangent vector at one end of one spline curve segment is directed to divide, by a predetermined ratio, a first angle; this first angle is formed by the first straight line and an extension of a second straight line connecting both ends of the previous spline curve segment; and

the tangent vector at the other end of one spline curve segment is directed to divide, by a predetermined ratio, a second angle; this second angle is formed by an extension of the first straight line and a third straight line connecting both ends of the next spline curve segment.

In the embodiment, the proportional constant “r” is not limited to “1”. It is possible to prevent a spline curve from containing loop portions provided that the proportional constant “r” is within a predetermined range.

The present invention can be applied to various types of robots without limiting such a vertical articulated robot.

In addition, those skilled in the art will appreciate that the present invention is capable of being distributed as program products, for example, the programs stored in the RAM 15 in a variety of forms. It is also important to note that the present invention applies equally regardless of the particular type of signal bearing media used to actually carry out the distribution. Examples of suitable signal bearing media include recordable type media such as CD-ROMs and DVD-ROMs, and transmission type media such as digital and analog communications links.

While there has been described what is at present considered to be the embodiments and their modifications of the present invention, it will be understood that various modifications which are not described yet may be made therein, and it is intended to cover in the appended claims all such modifications as fall within the true spirit and scope of the invention.

What is claimed is:

1. A controller for determining a spline curve as a trajectory of a predetermined movable portion of a robot body, the controller comprising:
an interpolating unit configured to sequentially interpolate spline curve segments respectively in sections corresponding to intervals between command points;
a tangent vector determining unit configured to determine tangent vectors at one and the other end of one spline curve segment of each of the sections such that:
a length of each of the tangent vectors is proportional to that of a first straight line connecting one end and the other end of the one spline curve segment; and
the tangent vectors at one end and the other end of the one spline curve segment are directed to divide, by a predetermined ratio, a first angle and a second angle, respectively, the first angle being formed by the first straight line and an extension of a second straight line connecting one and the other ends of a previous spline curve segment, the second angle being formed by the fist straight line and an extension of a third straight line connecting one and the other ends of a next spline curve segment; and
a linking unit configured to link the spline curve segments such that:
a direction of one of the tangent vectors at the one end of the one spline curve segment is substantially the same as that of one of the tangent vectors at the same end of the previous spline curve segment; and
a direction of the other of the tangent vectors at the other end of the one spline curve segment is substantially the same as that of one of the tangent vectors at the same end of the next spline curve segment.

2. A controller for sequentially interpolating spline curve segments according to claim 1, wherein the tangent vectors at one end and the other end of the one spline curve segment are directed to divide in half the first angle and the second angle, respectively.

3. A program product embedded in a memory of a controller for determining a spline curve as a trajectory of a predetermined movable portion of a robot body, the program product comprising:
first means for instructing a controller to sequentially interpolate spline curve segments respectively in sections corresponding to intervals between command points;
second means for instructing a controller to determine tangent vectors at one and the other end of one spline curve segment of each of the sections such that:
a length of each of the tangent vectors is proportional to that of a first straight line connecting one end and the other end of the one spline curve segment; and
the tangent vectors at one end and the other end of the one spline curve segment are directed to divide, by a predetermined ratio, a first angle and a second angle, respectively, the first angle being formed by the first straight line and an extension of a second straight line connecting one and the other ends of a previous spline curve segment, the second angle being formed by the fist straight line and an extension of a third straight line connecting one and the other ends of a next spline curve segment; and
third means for causing a controller to link the spline curve segments such that:
a direction of one of the tangent vectors at the one end of the one spline curve segment is substantially the same as that of one of the tangent vectors at the same end of the previous spline curve segment; and
a direction of the other of the tangent vectors at the other end of the one spline curve segment is substantially the same as that of one of the tangent vectors at the same end of the next spline curve segment.

4. A program product according to claim 3, wherein the tangent vectors at one end and the other end of the one spline curve segment are directed to divide in half the first angle and the second angle, respectively.

5. A method of determining a spline curve as a trajectory of a predetermined movable portion of a robot body, the method comprising:
sequentially interpolate spline curve segments respectively in sections corresponding to intervals between command points;
determining tangent vectors at one and the other end of one spline curve segment of each of the sections such that:
a length of each of the tangent vectors is proportional to that of a first straight line connecting one end and the other end of the one spline curve segment; and
the tangent vectors at one end and the other end of the one spline curve segment are directed to divide, by a predetermined ratio, a first angle and a second angle, respectively, the first angle being formed by the first straight line and an extension of a second straight line connecting one and the other ends of a previous spline curve segment, the second angle being formed by the fist straight line and an extension of a third straight line connecting one and the other ends of a next spline curve segment; and
linking the spline curve segments such that:
a direction of one of the tangent vectors at the one end of the one spline curve segment is substantially the same as that of one of the tangent vectors at the same end of the previous spline curve segment; and
a direction of the other of the tangent vectors at the other end of the one spline curve segment is substantially the same as that of one of the tangent vectors at the same end of the next spline curve segment.

6. A method according to claim 5, wherein the tangent vectors at one end and the other end of the one spline curve segment are directed to divide in half the first angle and the second angle, respectively.
